(19) United States
(12) Patent Application Publication
(10) Pub. No.: US 2025/0058663 A1
(43) Pub. Date: Feb. 20, 2025

(54) TEMPERATURE SENSOR FOR CHARGING INLET ASSEMBLY OF A VEHICLE

(71) Applicant: TE Connectivity Solutions GmbH, Schaffhausen (CH)

(72) Inventors: Ram Kishore Venkatesan, Winston Salem, NC (US); Kevin John Peterson, Kernersville, NC (US); Matthew Bryan Hitchcock, Hershey, PA (US); Nathan Philip Myer, Lancaster, PA (US); Aaron James de Chazal, Rochester, MI (US); Shubham Mittal, Bangalore (IN)

(21) Appl. No.: 18/479,162

(22) Filed: Oct. 2, 2023

(30) Foreign Application Priority Data
Aug. 18, 2023 (IN) 202341055464

(51) Int. Cl. B60L 53/302; B60L 53/16

(52) U.S. Cl. CPC B60L 53/302; B60L 53/16; H01R 13/6683

(57) ABSTRACT

A charging inlet assembly for an electric vehicle includes a charging inlet housing, charging terminals held in the charging inlet housing, and a temperature sensor plugged into the charging inlet housing for monitoring temperature of at least one of the charging terminals.

### CROSS REFERENCE TO RELATED APPLICATIONS

This application claims benefit to IN application No. 202341055464, filed 18 Aug. 2023, the subject matter of which is herein incorporated by reference in its entirety.

### BACKGROUND OF THE INVENTION

The subject matter herein relates generally to vehicle charging systems.

Electric vehicles (EV) and hybrid electric vehicles (HEV) include battery systems for operating the vehicles. The battery systems are charged by a vehicle charging system. For example, a charging connector, which is coupled to a power source, is connected to a charging inlet assembly of the vehicle to charge the battery. Known vehicle charging systems are not without disadvantages. For instance, the temperature of the terminals increase during charging, which may lead to damage to the charging components.

A need remains for temperature sensing of the terminals of the vehicle charging system for an electric vehicle.

### BRIEF DESCRIPTION OF THE INVENTION

In one embodiment, a charging inlet assembly for an electric vehicle is provided and includes a charging inlet housing that has terminal channels extending between a front and a rear of the charging inlet housing. The charging inlet assembly includes charging terminals received in the corresponding terminal channels and held in the charging inlet housing. The charging terminals have charging pins configured to be connected to charging sockets of a charging plug. The charging inlet assembly includes a temperature sensor plugged into the charging inlet housing at the rear for monitoring temperature of at least one of the charging terminals.

In another embodiment, a charging inlet assembly for an electric vehicle is provided and includes a charging inlet housing that has terminal channels extending between a front and a rear of the charging inlet housing. The charging inlet assembly includes charging terminals received in the corresponding terminal channels and held in the charging inlet housing. The charging terminals have charging pins configured to be connected to charging sockets of a charging plug. The charging inlet assembly includes a temperature sensor plugged into the charging inlet housing at the rear. The temperature sensor includes a first sensing element for monitoring temperature of a first charging terminal of the charging terminals and a second sensing element for monitoring temperature of a second charging terminal of the charging terminals.

In a further embodiment, a charging inlet assembly for an electric vehicle is provided and includes a charging inlet housing that has AC terminal channels and DC terminal channels extending between a front and a rear of the charging inlet housing. The charging inlet assembly includes AC charging terminals received in the corresponding AC terminal channels and held in the charging inlet housing. The AC charging terminals have charging pins configured to be connected to AC charging sockets of a charging plug. The charging inlet assembly includes DC charging terminals received in the corresponding DC terminal channels and held in the charging inlet housing. The DC charging terminals have charging pins configured to be connected to DC charging sockets of a charging plug. The charging inlet assembly includes an AC temperature sensor plugged into the charging inlet housing at the rear for monitoring temperature of at least one of the AC charging terminals. The charging inlet assembly includes a DC temperature sensor plugged into the charging inlet housing at the rear for monitoring temperature of at least one of the DC charging terminals.

### BRIEF DESCRIPTION OF THE DRAWINGS

FIG. 1 is a schematic view of a vehicle charging system in accordance with an exemplary embodiment.

FIG. 2 is a front perspective view of a charging component in accordance with an exemplary embodiment.

FIG. 3 is a rear perspective view of the charging component in accordance with an exemplary embodiment.

FIG. 4 is a rear perspective view of the charging inlet assembly in accordance with an exemplary embodiment showing one of the temperature sensors poised for loading into the charging inlet housing.

FIG. 5 is a sectional view of a portion of the charging inlet assembly in accordance with an exemplary embodiment.

FIG. 6 is a rear perspective view of the charging inlet assembly showing the temperature sensor in accordance with an exemplary embodiment poised for mating with the charging inlet housing.

FIG. 7 is a rear perspective view of a portion of the charging inlet assembly showing the temperature sensor shown in FIG. 6 mated with the charging inlet housing.

FIG. 8 is a rear perspective view of the charging inlet assembly showing the temperature sensor in accordance with an exemplary embodiment poised for mating with the charging inlet housing.

FIG. 9 is a rear perspective view of a portion of the charging inlet assembly showing the temperature sensor shown in FIG. 8 mated with the charging inlet housing in accordance with an exemplary embodiment.

FIG. 10 is a rear perspective view of the charging inlet assembly showing the temperature sensor in accordance with an exemplary embodiment.

FIG. 11 is a rear perspective view of the charging inlet assembly showing the temperature sensor shown in FIG. 10 poised for mating with the charging inlet housing in accordance with an exemplary embodiment.

FIG. 12 is an enlarged, rear perspective view of a portion of the charging inlet assembly showing the temperature sensor shown in FIG. 10 mated with the charging inlet housing in accordance with an exemplary embodiment.

FIG. 13 is a rear perspective view of the charging inlet assembly showing the temperature sensor in accordance with an exemplary embodiment poised for mating with the charging inlet housing.

FIG. 14 is a sectional view of a portion of the charging inlet assembly showing the temperature sensor shown in FIG. 13 mated with the charging inlet housing in accordance with an exemplary embodiment.

### DETAILED DESCRIPTION OF THE INVENTION

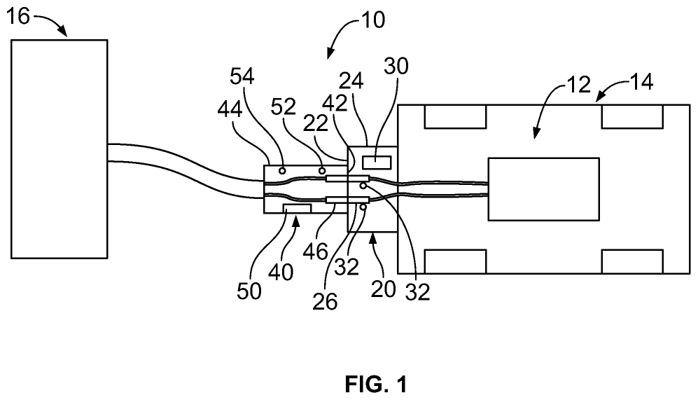

FIG. 1 is a schematic view of a vehicle charging system 10 in accordance with an exemplary embodiment. The vehicle charging system 10 is used for charging a battery system 12 of a vehicle 14, such as an electric vehicle or a hybrid electric vehicle. The vehicle charging system 10 includes a first charging component 20 and a second charging component 40. The first and second charging components 20, 40 are coupled together to charge the battery system 12 of the vehicle 14. In an exemplary embodiment, the first charging component 20 is coupled to the vehicle 14 and the second charging component 40 is coupled to a power supply 16 used for charging the battery system 12 of the vehicle 14. For example, the first charging component 20 may be a charging inlet assembly 22 mounted to the vehicle 14 and the second charging component 40 may be a charging connector 42 (for example, charging plug), which may be provided at a charging station or coupled to the building wiring of the home or building where the vehicle 14 is parked.

The first charging component 20 includes a housing 24 holding a plurality of charging terminals 26. The charging terminals 26 may be DC charging terminals and or AC charging terminals.

The first charging component 20 includes a charging controller 30, which may be used to control vehicle charging. For example, the charging controller 30 may control power supply along the charging terminals 26. The charging controller 30 may communicate with the second charging component 40, such as to control the second charging component 40. For example, the charging controller 30 may cause the second charging component 40 to turn on the power supply, turn off the power supply, increase power supply, and/or decrease power supply.

In an exemplary embodiment, the first charging component 20 includes one or more temperature sensors 32 operably coupled to the charging controller 30 to monitor a temperature of the charging terminals 26. The vehicle charging may be controlled based on the temperature readings of the temperature sensor 32.

The second charging component 40 includes a housing 44 holding a plurality of charging terminals 46. The charging terminals 46 are configured to be mated with the charging terminals 26. In various embodiments, the charging terminals 46 are socket terminals and the charging terminals 26 are pin terminals; however, other types of terminals may be used in alternative embodiments. The charging terminals 46 may be DC charging terminals and/or AC charging terminals.

The second charging component 40 includes a charging controller 50, which may be used to control vehicle charging. For example, the charging controller 50 may control power supply along the charging terminals 46. The charging controller 50 may communicate with the first charging component 20. The charging controller 50 may turn on the power supply, turn off the power supply, increase the power supply, and/or decrease the power supply. The charging controller 50 may control the voltage and/or current supplied by the second charging component 40.

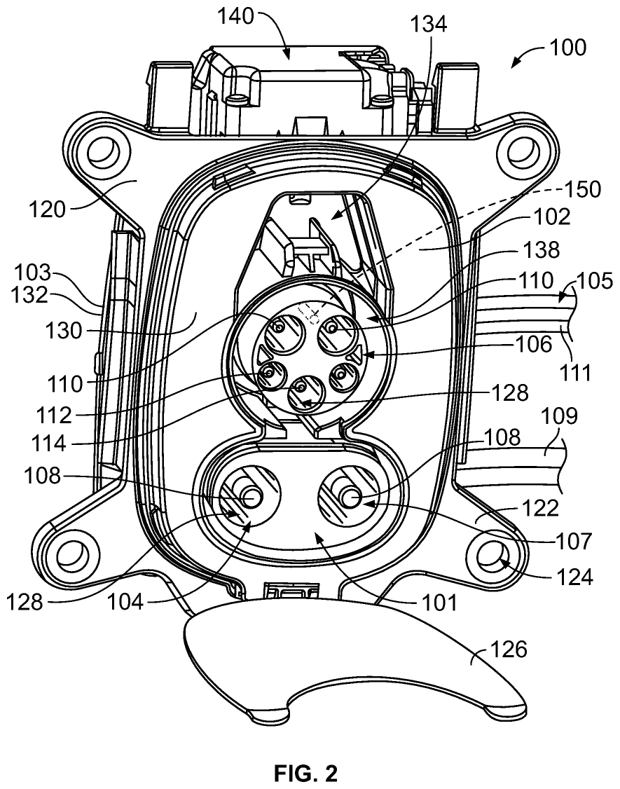

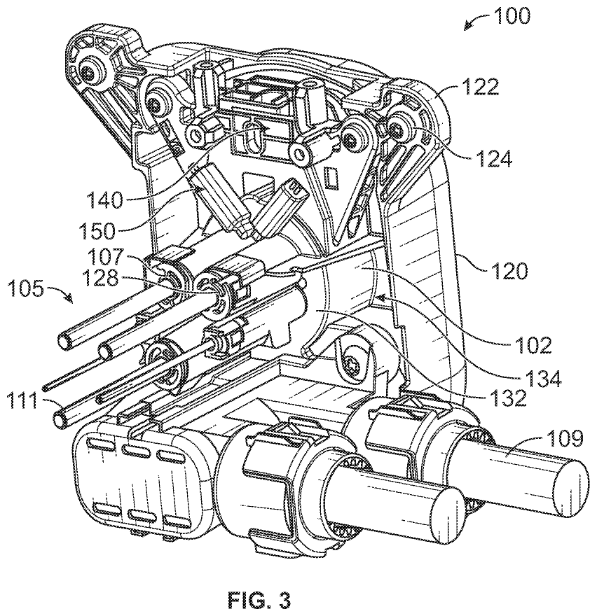

FIG. 2 is a front perspective view of a charging component 100 in accordance with an exemplary embodiment. FIG. 3 is a rear perspective view of the charging component 100 in accordance with an exemplary embodiment. In the illustrated embodiment, the charging component 100 is a charging inlet assembly and may be referred to hereinafter as a charging inlet assembly 100. The charging inlet assembly 100 is configured to be mated with a complimentary charging component (not shown), such as a charging connector or plug charger.

The charging inlet assembly 100 defines a power connector 101 configured to be electrically connected to the charging connector for charging a battery system of a vehicle, such as an electric vehicle (EV) or hybrid electric vehicle (HEV). In an exemplary embodiment, the charging inlet assembly 100 is configured for mating with a DC fast charging connector, such as the SAE combo CCS charging connector, in addition to AC charging connectors, such as the SAE J1772 charging connector. In various embodiments, the charging inlet assembly 100 has a CCS1 (5 pin) AC configuration. In other various embodiments, the charging inlet assembly 100 may have a CCS2 (7 pin) AC configuration. Other standard inlet configurations may be used in alternative embodiments.

The charging inlet assembly 100 includes a charging inlet housing 102 configured to be mounted in the vehicle. The charging inlet housing 102 forms a portion of the power connector 101 for mating with the charging connector. In an exemplary embodiment, the power connector 101 includes a DC charging portion 104 and an AC charging portion 106. The charging portions 104, 106 may form receptacles or openings that receive a plug of the charging connector. The charging inlet assembly 100 includes a plurality of charging terminals 107 for connection to the charging connector. Power cables 105 are electrically connected to the charging terminals 107 and routed within the vehicle, such as to the battery.

The DC charging portion 104 is configured for mating with a DC charging connector or a DC section of the charging connector. The DC charging portion may be used for fast charging. In an exemplary embodiment, the charging terminals 107 of the charging inlet assembly 100 includes DC charging terminals 108 at the DC charging portion 104, such as a pair of the DC charging terminals 108. The DC charging terminals 108 are configured to be electrically connected to the DC charging connector. The charging inlet assembly 100 includes DC power cables 109 (FIG. 2) electrically connected to the DC charging terminals 108. The DC power cables 109 may be terminated directly to the DC charging terminals 108, such as being crimped or welded to the DC charging terminals 108. In other embodiments, the DC power cables 109 may be electrically connected to the DC charging terminals 108 through a separable interface, such as through connectors mated to the charging inlet housing 102 at the rear.

The AC charging portion 106 is configured for mating with an AC charging connector or an AC section of the charging connector. In an exemplary embodiment (for example, CCS1), the charging terminals 107 of the charging inlet assembly 100 include AC power terminals 110 at the AC charging portion 106, such as a pair of the AC power terminals 110 (for example, a line terminal and a neutral terminal). In other embodiments (for example, CCS2), the charging terminals 107 includes four AC power terminals 110 (for example, L1, L2, L3, N). The charging terminals 107 of the charging inlet assembly 100 may include other terminals, such as a proximity terminal, a ground terminal, and a communication terminal at the AC charging portion 106. The AC power terminals, the proximity terminal, the ground terminal, and the communication terminal are configured to be electrically connected to the AC charging connector.

The charging inlet assembly 100 includes AC cables 111 (FIG. 2) electrically connected to the corresponding charging terminals 110. The AC cables 111 may be terminated directly to the charging terminals 107, such as being crimped or welded thereto. In other embodiments, the AC cables 111 may be electrically connected to the charging terminals 107 through a separable interface, such as through connectors mated to the charging inlet housing 102 at the rear.

The cables 109, 111 extend from the charging inlet assembly 100 to another component of the vehicle, such as the battery system of the vehicle. The cables 109, 111 transmit power (and may transmit data signals), such as to the battery of the vehicle. The DC power cables 109 may transmit high voltage for charging the battery and the AC cables 111 may transmit low voltage for charging the battery. Optionally, one or more of the cables 111 may be electrically connected to a battery control unit (not shown) of the battery system, such as to transmit data between the charging inlet assembly 100 and the battery system, such as data relating to the charging operation. For example, the cable 111 may transmit data relating to charging start/stop, operating temperature of the power terminals 108 and/or 110, or other charging data. The cable 111 may send a proximity signal to the battery system indicating when the charging device is mated to the power connector 101 of the charging inlet assembly 100.

The charging inlet assembly 100 includes a mounting flange 120 (FIG. 1) extending from the charging inlet housing 102. The mounting flange 120 may be a separate piece coupled to the charging inlet housing 102. The mounting flange 120 is used to couple the charging inlet assembly 100 to the vehicle. The mounting flange 120 includes mounting tabs 122 having openings 124 that receive fasteners (not shown) used to secure the charging inlet assembly 100 to the vehicle. Other types of mounting features may be used to secure the charging inlet assembly 100 to the vehicle. The mounting flange 120 may include a seal to seal the charging inlet assembly 100 to the vehicle.

In an exemplary embodiment, the charging inlet assembly 100 includes a terminal cover 126 (FIG. 2) at a front 130 of the charging inlet housing 102. The terminal cover 126 is hingedly coupled to the mounting flange 120 and/or the charging inlet housing 102. The terminal cover 126 is used to cover portions of the charging inlet housing 102, such as the power connector 101. The terminal cover 126 may be used to cover the DC charging terminals 108 and/or the AC power terminals 110, which are located in corresponding terminal channels 128 in the charging inlet housing 102. The charging inlet housing 102 may include a rear cover at a rear 132 of the charging inlet housing 102 to close access to a rear portion of the charging inlet housing 102.

In an exemplary embodiment, the charging inlet housing 102 of the charging inlet assembly 100 includes an internal cavity 134 that receives the components of the charging inlet assembly 100. The internal cavity 134 includes the terminal channels 128 that receive the corresponding charging terminals 107. The internal cavity 134 includes a front chamber 138 at the front that receive the charging connector.

In an exemplary embodiment, the charging inlet assembly 100 includes a charging controller 140 for controlling charging of the vehicle through the charging inlet assembly 100. The charging controller 140 may be received in the internal cavity 134, such as at the rear 132. Alternatively, the charging controller 140 may be located remote from the charging inlet housing 102. The charging controller 140 may be communicatively coupled to the other charging component, such as the charging connector or plug, to control the charging activity. The charging controller 140 may turn on the power supply, turn off the power supply, increase the power supply, and/or decrease the power supply.

In an exemplary embodiment, the control assembly includes one or more temperature sensors 150 used to control the charging operation. The temperature sensors 150 are used to monitor temperature of one or more of the charging terminals 107. The charging operation may be controlled based on the operating temperatures of the charging terminals 107. The temperature sensor(s) 150 are connected to the charging controller 140 by wires. The temperature sensors 150 may monitor operating temperatures of the DC charging terminals 108 and/or the AC charging terminals 110. For example, as the temperature increases or approaches an allowable operating temperature, the power supply may be decreased. For example, the voltage or current may be reduced. The charging operation may stop if the operating temperature of the charging terminals 107 is above a threshold temperature.

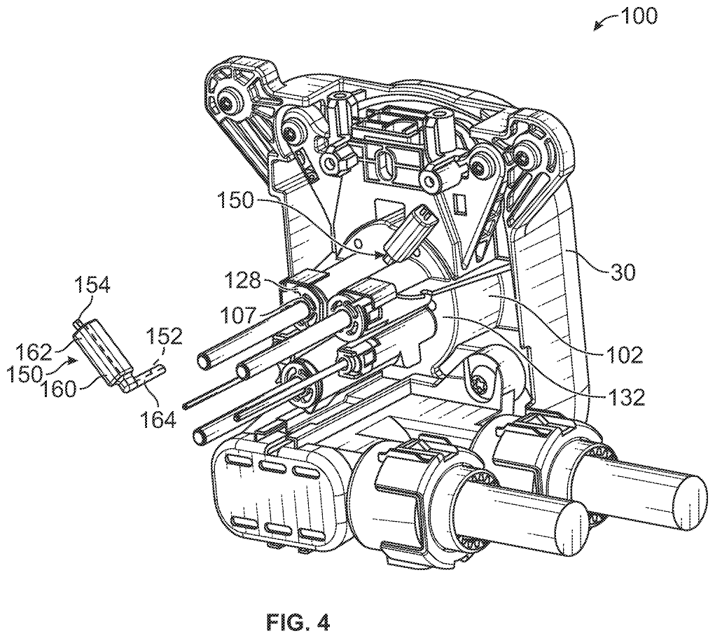

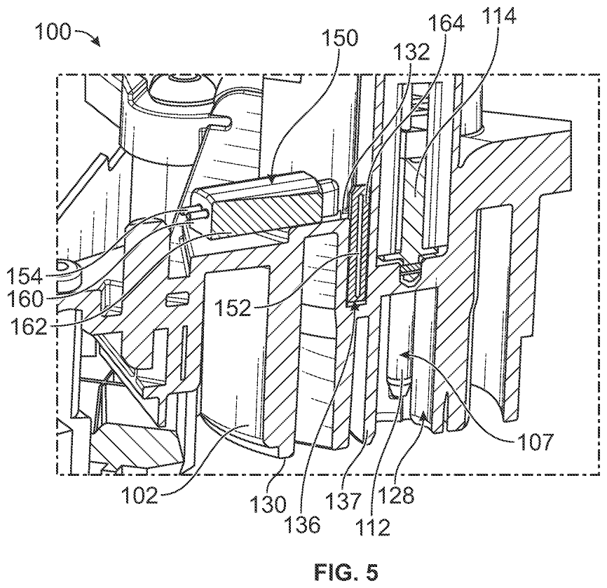

FIG. 4 is a rear perspective view of the charging inlet assembly 100 in accordance with an exemplary embodiment showing one of the temperature sensors 150 poised for loading into the charging inlet housing 102. FIG. 5 is a sectional view of a portion of the charging inlet assembly 100 in accordance with an exemplary embodiment.

The temperature sensor 150 is configured to be plugged into the rear 132 of the charging inlet housing 102 for monitoring temperature of at least one of the charging terminals 107. In various embodiments, multiple temperature sensors 150 may be provided to monitor the temperature of different charging terminals 107. Each temperature sensor 150 may monitor the temperature of a single charging terminal 107 alternatively, each temperature sensor 150 may monitor the temperature of multiple charging terminals 107. In the illustrated embodiment, the temperature sensors 150 are used to monitor the AC charging terminals; however, the temperature sensors 150 may additionally or alternatively be used to monitor the DC charging terminals.

In an exemplary embodiment, the temperature sensor 150 is plugged into a sensor bore 136 of the charging inlet housing 102. In the illustrated embodiment, the sensor bore 136 is open at the rear 132 to receive a portion of the temperature sensor 150. The sensor bore 136 is located proximate to the terminal channel 128 to position the temperature sensor 150 in close proximity to the charging terminal 107. Optionally, the sensor bore 136 may extend parallel to the terminal channel 128, such as in a direction passing straight through the charging inlet housing 102 between the rear 132 and the front 130. In an exemplary embodiment, the sensor bore 136 extends only partially through the charging inlet housing 102 such that the sensor bore 136 is open at the rear 132 to receive the temperature sensor 150 but is closed at the front 130. In an exemplary embodiment, a separating element 137 is provided to electrically isolate the temperature sensor 150 from the charging terminal 107. Optionally, a portion of the charging inlet housing 102 is located between the sensor bore 136 and the terminal channel 128 to electrically isolate the temperature sensor 150 from the charging terminal 107. For example, the separating element 137 may be a thin separating wall of the charging inlet housing 102 that separates the sensor bore 136 from the terminal channel 128 to allow the temperature sensor 150 to quickly and accurately monitor rising temperature of the charging terminal 107. Other types of separating elements 137 may be used in alternative embodiments, such as a thermal pad that is placed between the components. In other various embodiments, the separating element 137 may be part of the temperature sensor 150, such as a shell, wall, coating, and the like. In the illustrated embodiment, the sensor bore 136 is circular; however, the sensor bore 136 may have other shapes in alternative embodiments.

The temperature sensor 150 includes one or more sensor elements 152 and a sensor housing 160 surrounding and holding the sensor element(s) 152. Each sensor element 152 may be a thermistor or other type of temperature sensing device. One or more sensor wires 154 are connected to the sensor element 152 and extend from the sensor housing 160. For example, the sensor wires 154 may be spliced, soldered or crimped to leads of the sensor element 152 at an interface, which is surrounded by the sensor housing 160. In various embodiments, the sensor wires 154 include one or more signal wires and one or more ground wires. The sensor housing 160 encloses the termination between the sensor wires 154 and the sensor element 152, such as to prevent damage to the component or degradation due to moisture or debris.

The sensor housing 160 is manufactured from a dielectric material, such as a plastic material. The sensor housing 160 may be a molded plastic housing. In various embodiments, the sensor housing 160 is molded in place (for example, overmolded) around the sensor element 152 and/or the sensor wires 154. In an exemplary embodiment, the sensor housing 160 is manufactured from an electrically insulating and thermally conductive material. Heat is transferred through the sensor housing 160 to the sensor element 152.

The sensor housing 160 includes a main body 162 and an extension 164 extending from the main body 162. The sensor element 152 is located in the extension 164. The extension 164 is configured to be plugged into the sensor bore 136 of the charging inlet housing 102. For example, the extension 164 is sized and shaped to fit in the sensor bore 136. The extension 164 is plugged into the sensor bore 136 such that the sensor element 152 is positioned forward of the rear 132 of the charging inlet housing 102, which locates the sensor element 152 proximate to the mating interface of the charging terminal 107. Optionally, the extension 164 may engage the charging inlet housing 102 by an interference fit to hold the extension 164 in the sensor bore 136. In various embodiments, the extension 164 and/or the sensor bore 136 may have a thermal interface material applied thereto to enhance thermal transfer between the charging inlet housing 102 and the extension 164 to allow accurate temperature monitoring by the temperature sensor 150. The thermal interface material defines a thermal bridge between the components, such as between the extension 164 of the sensor housing 160 and the material of the charging inlet housing 102 surrounding the sensor bore 136. The main body 162 surrounds the interface between the sensor wire 154 and the sensor element 152. Optionally, the sensor housing 160 may include a rear extension extending from the main body 162 along a portion of the sensor wires 154. In an exemplary embodiment, the sensor housing 160 includes a securing element, such as a latch, extending from the sensor housing 160 to secure the temperature sensor 150 to the charging inlet housing 102. The sensor housing 160 may be removably coupled to the charging inlet housing 102 using the latch.

When assembled, the temperature sensor 150 is coupled to the charging inlet housing 102 proximate to the charging terminal 107. The sensor element 152 is plugged into the sensor bore 136 such that the sensor element 152 is located proximate to the charging terminal 107. During charging, the temperature sensor 150 monitors the temperature increase of the charging terminal 107. For example, the sensor element 152 may be located in close proximity to the mating interface between the charging terminal 107 and the corresponding charging terminal of the charging plug connected to the charging inlet assembly 100. In the illustrated embodiment, the charging terminal 107 includes a charging pin 112 at a mating end of the charging terminal 107. The charging pin 112 is configured to be plugged into a charging socket of the charging plug. Power is transferred from the charging socket to the charging pin 112 at a mating interface. The sensor element 152 of the temperature sensor 150 is located in close proximity to the mating interface, which is the heat generating area of the charging terminal 107. The sensor element 152 may additionally or alternatively be located proximate to a cable barrel 114 at a terminating end of the charging terminal 107. The cable barrel 114 is the portion of the charging terminal 107 connected to the power cable. The cable barrel 114 is located at the rear of the charging inlet housing 102, such as rearward of the sealed interface between the charging terminal 107 and the charging inlet housing 102. It may be possible for the sensor element 152 to be located closer to the cable barrel 114 because the cable barrel 114 is located rearward of the sealed interface. In various embodiments, the sensor element 152 may directly engage the charging terminal 107, such as at the cable barrel 114 to quickly and accurately monitor a temperature of the charging terminal 107.

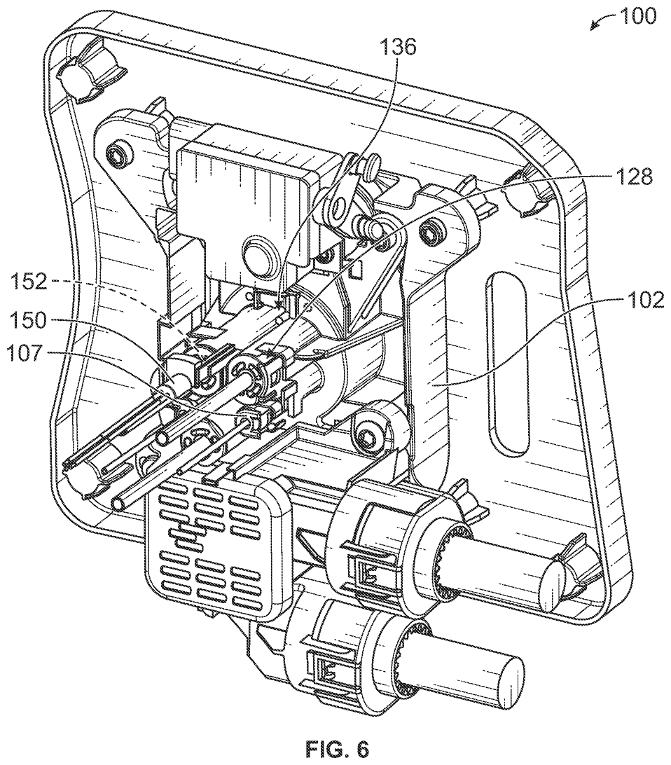

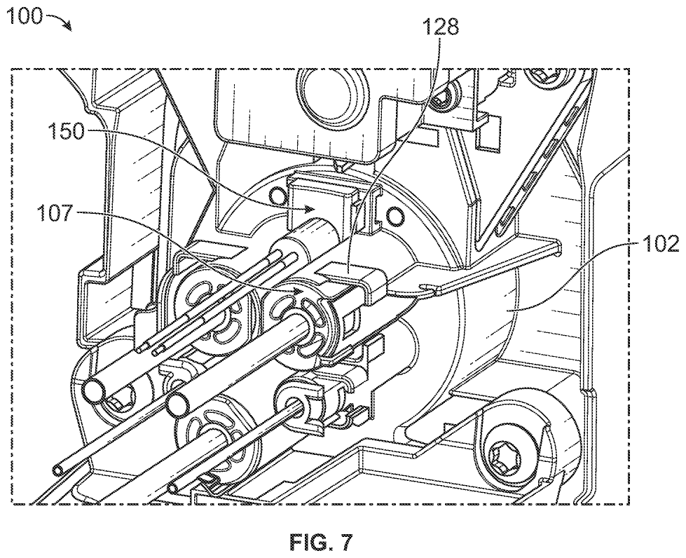

FIG. 6 is a rear perspective view of the charging inlet assembly 100 showing the temperature sensor 150 in accordance with an exemplary embodiment poised for mating with the charging inlet housing 102. FIG. 7 is a rear perspective view of a portion of the charging inlet assembly 100 showing the temperature sensor 150 shown in FIG. 6 mated with the charging inlet housing 102.

In the illustrated embodiment, the sensor bore 136 is located between a pair of the terminal channels 128. The temperature sensor 150 is plugged into the sensor bore 136 such that the sensor element 152 is located between, such as positioned equidistant relative to, the charging terminals 107 in both of the terminal channels 128. As such, a single sensor element 152 is used to monitor the temperature of multiple charging terminals 107 (for example, a pair of the charging terminals 107). Using a single temperature sensor 150 to monitor multiple charging terminals 107 reduces part and simplifies assembly.

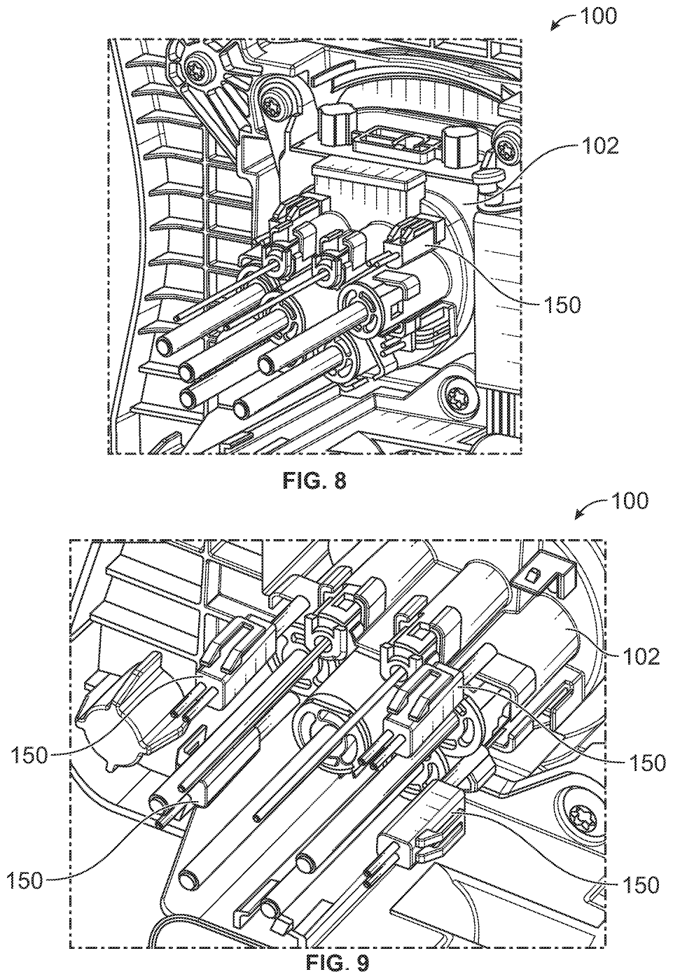

FIG. 8 is a rear perspective view of the charging inlet assembly 100 showing the temperature sensor 150 in accordance with an exemplary embodiment poised for mating with the charging inlet housing 102. FIG. 9 is a rear perspective view of a portion of the charging inlet assembly 100 showing the temperature sensor 150 shown in FIG. 8 mated with the charging inlet housing 102.

In the illustrated embodiment, the charging inlet assembly 100 is a CCS2 charging inlet assembly having a seven AC charging terminal configuration, including line 1, line 2, line 3, and neutral (L1, L2, L3, N) charging terminals. The charging inlet assembly 100 includes a plurality of the temperature sensors 150, such as a temperature sensor 150 for each of the L1, L2, L3, and N charging terminals.

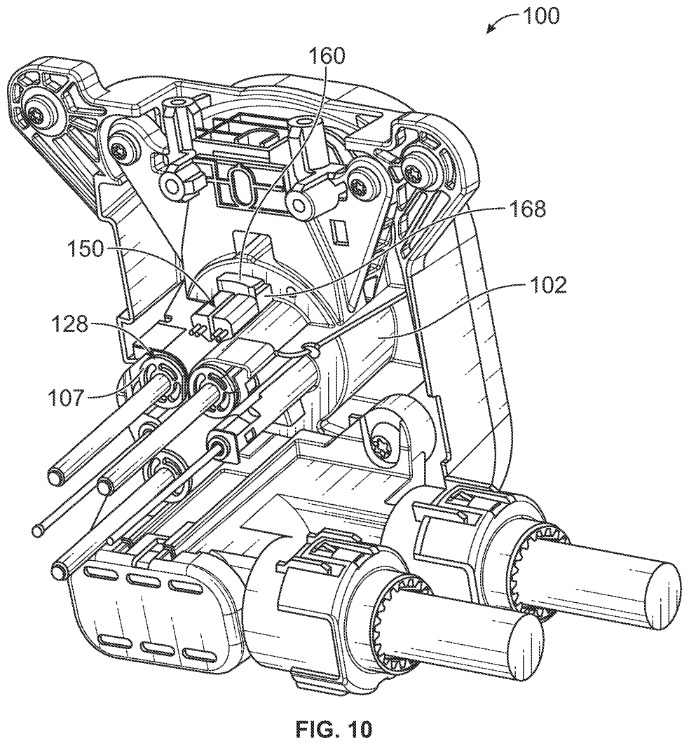

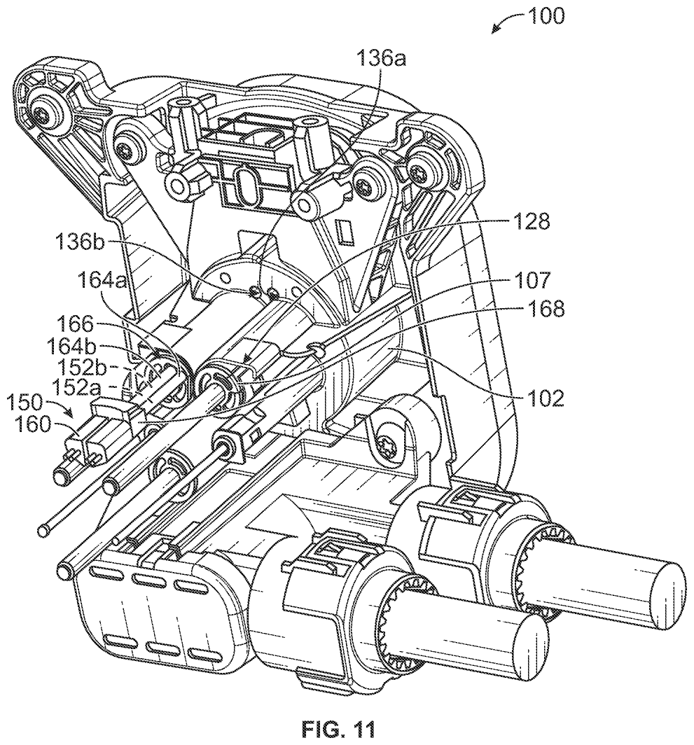

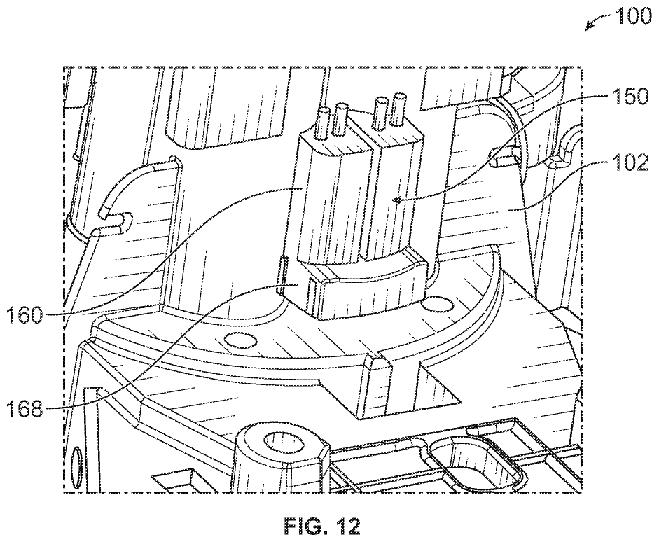

FIG. 10 is a rear perspective view of the charging inlet assembly 100 showing the temperature sensor 150 in accordance with an exemplary embodiment. FIG. 11 is a rear perspective view of the charging inlet assembly 100 showing the temperature sensor 150 shown in FIG. 10 poised for mating with the charging inlet housing 102. FIG. 12 is an enlarged, rear perspective view of a portion of the charging inlet assembly 100 showing the temperature sensor 150 shown in FIG. 10 mated with the charging inlet housing 102.

In the illustrated embodiment, the temperature sensor 150 includes a pair of the sensor elements 152 held in the same sensor housing 160. For example, the temperature sensor 150 includes a first sensor element 152a and a second sensor element 152b. The first sensor element 152a is held in a first extension 164a and the second sensor element 152b is held in a second extension 164b. The first extension 164a is separated from the second extension 164b by a gap 166. The first extension 164a and corresponding first sensor element 152a is configured to be plugged into a first sensor bore 136a and the second extension 164b and corresponding second sensor element 152b is configured be plugged into a second sensor bore 136b. For example, the temperature sensor 150 may be coupled to the charging inlet housing 102 at a location approximately centered between the corresponding charging terminals 107. The first and second sensor elements 152a, 152b are used to monitor temperature of two different charging terminals 107. The first sensor element 152a may be located proximate to the terminal channel 128 holding the first charging terminal 107 and the second sensor element 152b may be located proximate to the terminal channel 128 holding the second charging terminal 107. Using a single sensor housing 160 to hold the pair of sensor elements 152a, 152b reduces part and simplifies assembly. For example, both sensor elements 152a, 152b may be simultaneously loaded into the charging inlet housing 102 and secured to the charging inlet housing 102 using the latches 168 of the common sensor housing 160. The temperature sensor 150 may share sensor wires 154 4 the pair of the sensor elements 152a, 152b, such as a shared ground wire.

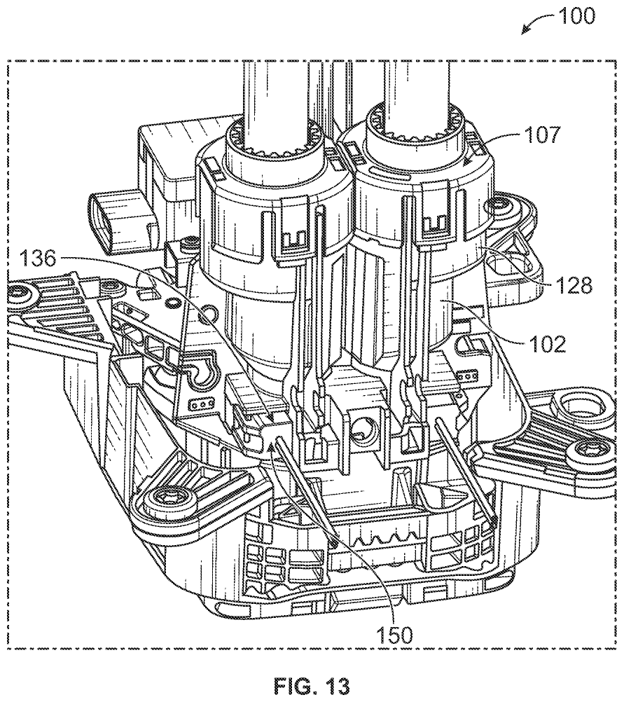

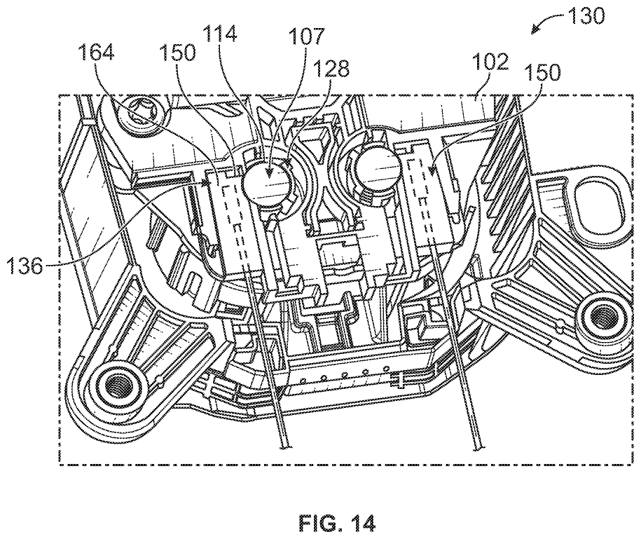

FIG. 13 is a rear perspective view of the charging inlet assembly 100 showing the temperature sensor 150 in accordance with an exemplary embodiment poised for mating with the charging inlet housing 102. FIG. 14 is a sectional view of a portion of the charging inlet assembly 100 showing the temperature sensor 150 shown in FIG. 13 mated with the charging inlet housing 102.

In the illustrated embodiment, multiple temperature sensors 150 are shown. The temperature sensors 150 are used to monitor temperature of the DC charging terminals. The DC charging terminal temperature sensors may be used with any of the other embodiments shown in FIGS. 2-12 to monitor both AC charging terminals and DC charging terminals. The temperature sensors 150 are received in corresponding sensor bores 136. In the illustrated embodiment, the sensor bores 136 are open to the terminal channels 128. The temperature sensors 150 are plugged into the sensor bores 136 to engage the charging terminals 107, such as along the cable barrel 114. The temperature sensors 150 are thermally coupled to the charging terminals 107 to directly monitor the temperatures of the charging terminals 107. Thermal interface material may be located between the extensions 164 and the charging terminals 107 to enhance thermal coupling between the temperature sensors 150 and the charging terminals 107.

In an embodiment, a temperature sensing assembly for a charging inlet assembly of a vehicle is provided. The temperature sensing assembly is a shared temperature sensor for AC charging terminals of a CCS1 type charging inlet assembly. The temperature sensor is located in a sensor housing coupled to the housing of the charging inlet assembly. The shared temperature sensor may be located between two AC terminals, such as the line and neutral charging terminals. The temperature sensor is located in close proximity to the mating interfaces of the charging pins with the socket terminals of the charging plug. The temperature sensor assembly is configured to be latchably coupled to the inlet housing. The temperature sensor assembly is removable from the charging inlet assembly, such as for repair, replacement, or reuse. The sensor housing may be a thermally conductive plastic. A thermal interface material may be provided on the end of the sensor or in the bore of the charging inlet housing to improve thermal connection between the temperature sensor and the charging terminals.

In an embodiment, a temperature sensing assembly for a charging inlet assembly of a vehicle is provided. The temperature sensing assembly includes multiple temperature sensors used for corresponding AC charging terminals of a CCS1 type charging inlet assembly. The temperature sensors have their own separate housings. The temperature sensors may be 90° sensors. The temperature sensor may be located in close proximity to the interface of the charging pin. The temperature sensors are configured to be latchably coupled to the inlet housing. The temperature sensors are removable from the charging inlet assembly, such as for repair, replacement, or reuse. The sensor housing may be a thermally conductive plastic. A thermal interface material may be provided on the end of the sensor or in the bore of the charging inlet housing to improve thermal connection between the temperature sensor and the charging terminals.

In an embodiment, a temperature sensing assembly for a charging inlet assembly of a vehicle is provided. The temperature sensing assembly includes multiple temperature sensors used for corresponding AC charging terminals of a CCS2 type charging inlet assembly. For example, the temperature sensors may be used to sense the L1, L2, L3 and N charging terminals.

In an embodiment, a temperature sensing assembly for a charging inlet assembly of a vehicle is provided. The temperature sensing assembly includes multiple temperature sensors used for corresponding AC charging terminals of a CCS1 type charging inlet assembly. The temperature sensors are contained in a common sensor housing. The temperature sensors are received in different openings or bores in the inlet housing. The temperature sensors are separated by an insulator, such as an air gap. The temperature sensor may share a common ground wire to reduce the total number of wires, connection and weight of the temperature sensing assembly. The dual sensors may be used with CCS2 type charging inlet assembly, such as one dual sensing assembly for L1 and L2 and a different dual sensing assembly for L3 and N. In other embodiments, a quad sensing assembly may be used having four sensors, one for each of the L1, L2, L3 and N terminals. Such quad sensing assembly may be located in the middle of the terminals.

In an embodiment, a temperature sensing assembly for a charging inlet assembly of a vehicle is provided. The temperature sensing assembly includes multiple temperature sensors used for corresponding DC charging terminals of a charging inlet assembly. The temperature sensors have their own separate housings. The temperature sensors may be configured to directly interface with the charging terminals for monitoring the temperature of the charging terminals. The temperature sensor may be located in close proximity to the interface of the charging pin. The temperature sensors are configured to be latchably coupled to the inlet housing. The temperature sensors are removable from the charging inlet assembly, such as for repair, replacement, or reuse. The sensor housing may be a thermally conductive plastic. A thermal interface material may be provided on the end of the sensor or in the bore of the charging inlet housing to improve thermal connection between the temperature sensor and the charging terminals.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A charging inlet assembly for an electric vehicle comprising:
a charging inlet housing having terminal channels extending between a front and a rear of the charging inlet housing;
charging terminals received in the corresponding terminal channels and held in the charging inlet housing, the charging terminals having charging pins configured to be connected to charging sockets of a charging plug; and
a temperature sensor plugged into the charging inlet housing at the rear for monitoring temperature of at least one of the charging terminals.

2. The charging inlet assembly of claim 1, wherein the temperature sensor is removably coupled to the charging inlet housing.

3. The charging inlet assembly of claim 1, wherein the temperature sensor includes a latch, the latch being latchably coupled to the charging inlet housing.

4. The charging inlet assembly of claim 1, wherein the charging inlet housing includes a sensor bore at the rear, the temperature sensor being plugged into the sensor bore.

5. The charging inlet assembly of claim 1, wherein the temperature sensor includes a sensor element received in the charging inlet housing forward of the rear, the sensor element located proximate to the corresponding charging terminal.

6. The charging inlet assembly of claim 1, further comprising a separating element between the temperature sensor and the charging terminal to electrically isolate the charging terminal from the temperature sensor.

7. The charging inlet assembly of claim 1, wherein the temperature sensor is generally centered between a first charging terminal of the charging terminals and a second charging terminal of the charging terminals to monitor temperature of the first and second charging terminals.

8. The charging inlet assembly of claim 1, wherein the temperature sensor includes a first sensing element and a second sensing element, the first sensing element located proximate to a first charging terminal of the charging terminals, the second sensing element located proximate to a second charging terminal of the charging terminals.

9. The charging inlet assembly of claim 8, wherein the first sensing element is separated from the second sensing element by a gap.

10. The charging inlet assembly of claim 8, wherein the charging inlet housing includes a first sensor bore proximate to the terminal channel holding the first charging terminal and a second sensor bore proximate to the terminal channel holding the second charging terminal, the first sensing element received in the first sensor bore, the second sensing element received in the second sensor bore.

11. The charging inlet assembly of claim 1, wherein the temperature sensor includes a sensor element and a sensor housing surrounding and holding the sensor element.

12. The charging inlet assembly of claim 11, wherein the sensor housing is manufactured from an electrically insulating and thermally conductive material.

13. The charging inlet assembly of claim 11, wherein the temperature sensor includes a sensor wire terminated to the sensor element at an interface, the sensor housing surrounding the interface.

14. The charging inlet assembly of claim 1, wherein the temperature sensor includes a thermal interface material defining a thermal bridge between the temperature sensor and the charging terminal.

15. The charging inlet assembly of claim 1, wherein the temperature sensor is a first temperature sensor, the charging inlet assembly further comprising a second temperature sensor plugged into the charging inlet housing at the rear for monitoring temperature of at least one of the charging terminals.

16. The charging inlet assembly of claim 1, wherein the temperature sensor directly engages the corresponding charging terminal to monitor temperature of the charging terminals.

17. A charging inlet assembly for an electric vehicle comprising:
a charging inlet housing having terminal channels extending between a front and a rear of the charging inlet housing;
charging terminals received in the corresponding terminal channels and held in the charging inlet housing, the charging terminals having charging pins configured to be connected to charging sockets of a charging plug; and
a temperature sensor plugged into the charging inlet housing at the rear, the temperature sensor including a first sensing element for monitoring temperature of a first charging terminal of the charging terminals and a second sensing element for monitoring temperature of a second charging terminal of the charging terminals.

18. The charging inlet assembly of claim 17, wherein the temperature sensor includes a common housing holding the first and second sensing elements, the first sensing element being separated from the second sensing element by a gap at a front of the temperature sensor.

19. The charging inlet assembly of claim 17, wherein the charging inlet housing includes a first sensor bore proximate to the terminal channel holding the first charging terminal and a second sensor bore proximate to the terminal channel holding the second charging terminal, the first sensing element received in the first sensor bore, the second sensing element received in the second sensor bore.

20. A charging inlet assembly for an electric vehicle comprising:
a charging inlet housing having AC terminal channels and DC terminal channels extending between a front and a rear of the charging inlet housing;
AC charging terminals received in the corresponding AC terminal channels and held in the charging inlet housing, the AC charging terminals having charging pins configured to be connected to AC charging sockets of a charging plug;
DC charging terminals received in the corresponding DC terminal channels and held in the charging inlet housing, the DC charging terminals having charging pins configured to be connected to DC charging sockets of a charging plug;
an AC temperature sensor plugged into the charging inlet housing at the rear for monitoring temperature of at least one of the AC charging terminals; and
a DC temperature sensor plugged into the charging inlet housing at the rear for monitoring temperature of at least one of the DC charging terminals.
